(19) United States
(12) Patent Application Publication
(10) Pub. No.: US 2002/0171725 A1
(43) Pub. Date: Nov. 21, 2002

(54) Ink jet printer and ink composition therefor

(76) Inventors: Akemi Ouchi, Ibaraki (JP); Tsutomu Maekawa, Ibaraki (JP); Kunihiro Tamahashi, Ibaraki (JP); Atsushi Kakuta, Hokkaido (JP)

Correspondence Address: McGinn & Gibb, PLLC, Suite 200, 8321 Old Courthouse Road, Vienna, VA, 22182-3817, US

(21) Appl. No.: 10/067,764

(22) Filed: Feb. 8, 2002

(30) Foreign Application Priority Data
Feb. 9, 2001 (JP) P. 2001-033079

(51) Int. Cl. G01D 11/00

(52) U.S. Cl. 347/100

(57) ABSTRACT

An ink jet printer which performs recording by allowing an ink droplet to be attached to plain paper, characterized in that there is used an ink composition comprising at least water, a pigment and a water-soluble organic solvent which exhibits a weight loss of from 10% to 40% based on the total weight of ink, a 25° C. surface tension increase of not smaller than 1 mN/m from the initial value and a viscosity change of not greater than 150% of the initial value after 24 hours of aging at a temperature of 25° C. and 60%RH (relative humidity)

### BACKGROUND OF THE INVENTION

1. Field of the Invention

The present invention relates to an ink composition for use in an ink jet recording device which performs high speed recording on plain paper.

2. Description of the Related Art

Heretofore, a water-soluble liquid ink composition has widely been used as an ink composition for ink jet printing. However, when such an ink composition is printed on plain paper such as copying paper commonly used in offices, the ink thus printed runs along the fibers of the paper, giving irregular dot forms and hence causing so-called feathering.

Various improvements have been made for the purpose of eliminating oozing and improving dryability. For example, JP-B-60-34992 (The term “JP-B” as used herein means an “examined Japanese patent application”) proposes that a large amount of a surface active agent be used to lower the surface tension of ink and hence improve the dryability thereof. Further, JP-A-58-108271 (The term “JP-A” as used herein means an “unexamined published Japanese patent application”) discloses a method involving recording with a hot-melt ink composition comprising a wax which normally stays solid. U.S. Pat. Nos. 4,391,369 and 4,484,948 disclose an ink composition which provides a good print quality regardless of paper quality.

In ink jet recording, it has been normally practiced to use a special substrate (ink jet paper) in order to prevent excessive penetration and running of ink droplet and hence realize printing with a high density and brightness and improve water resistance and storage properties. Many reports have been already made concerning this practice. For example, U.S. Pat. Nos. 5,854,649 and 5,853,899, JP-A-11-192778, JP-A-11-129610, JP-A-11-078223, JP-A-11-078221, JP-A-11-034485, JP-A-11-028861, JP-A-11-020300, Japanese Patent No. 2845832, and JP-W-11-506991 disclose that a specific water-soluble resin can be applied to a substrate to improve the ink adsorptivity thereof. For example, U.S. Pat. No. 5,516,364, JP-A-11-192775, JP-A-11-157207, JP-A-11-129606, JP-A-11-048604, JP-A-11-034481, Japanese Patent Nos. 2938917, 2887098, 2883299 and 2877740 disclose that a specific inorganic material such as clay and alumina can be incorporated in a substrate to improve the ink adsorptivity thereof and hence allow high quality printing.

In recent years, there has been a growing demand for high quality printing on not only paper dedicated for ink jet printing but also plain paper. This problem can be unavoidably encountered not only with the demand for reduction of paper cost but also with the case where ink jet recording is applied also to printing methods which have heretofore been accomplished otherwise (e.g., show through, ink printing such as flexographic printing, laser printing, non-impact printing such as heat-sensitive recording, impact printing). In particular, in the art of office printing involving high speed printing of a large amount of office documents such as standard document and slip, the use of plain paper and high speed printing are indispensable. Thus, this demand cannot be met by the used of the conventional ink for ink jet printing and printing method intended for dedicated paper.

Referring to water-soluble liquid ink composition, JP-A-2-233781 discloses a recording liquid made of a water-soluble medium and a dye comprising a water-soluble organic solvent consisting of diethylene glycol, glycerin and polyethylene glycol incorporated as a humectant therein in an amount of from 4 to 20% by weight. Japanese Patent No. 2516218 discloses a recording method on a paper having a stockigt sizing degree of not 10 with a composition comprising a dye, a modifier and water the sum of the dynamic surface tension and viscosity of which is from 42 to 49. Japanese Patent No. 02801295 discloses a method involving recording on a recording material having a stockigt sizing degree of from 0 to 15 with a recording liquid having an optimized dye concentration. Japanese Patent No. 2529154 discloses an ink jet composition comprising a non-aqueous solvent having an evaporation rate of less than one tenth of that of butyl acetate.

On the other hand, as an ink colorant there is normally used a pigment to improve the weathering resistance of printed matter. Such an ink composition is used for various printers such as laser printer, melt-transfer type printer, liquid ink jet printer and solid ink jet printer.

Concerning pigment inks, many reports have been made as in JP-A-3-37278, JP-A-4-339871, JP-A-5-16343, JP-A-5-105832, JP-A-6-49400, JP-A-6-228479, JP-A-6-228480, JP-A-6-306319, JP-A-7-109432, JP-A-7-196968, JP-A-7-278477, JP-A-7-306319, JP-A-7-316479, JP-A-7-331141, and JP-A-8-295836. However, most of ink jet recording liquids which are commonly spread comprise an aqueous medium and a dye. This is because if a pigment is used, constituents can hardly be combined to keep the pigment stably dispersed, making it difficult to store the recording liquid in a stable manner over an extended period of time.

Unlike the recording liquid comprising a dye soluble in an aqueous medium, the recording liquid comprising a pigment can easily cause clogging in the nozzle of the recording head because the pigment is insoluble in the aqueous solvent and normally stays solid. Thus, the recording liquid comprising a pigment needs to comprise a large amount of a humectant such as polyalkylene glycol and glycerin incorporated therein. For example, JP-A-3-1577464 discloses a recording liquid comprising a pigment and proposes that the recording liquid preferably comprises a humectant incorporated therein in an amount of from 30 to 80 parts based on 100 parts of water. An approach has been attempted which comprises adding a large amount of a humectant to prevent the agglomeration of a pigment. However, this approach is disadvantageous in that the resulting recording liquid exhibits a raised viscosity that deteriorates the ejectability thereof. JP-B-5-30870 discloses an aqueous pigment ink comprising trimethyl pentanediol monoisobutyrate and ethylene glycol monobutyl ether incorporated therein to prevent the rise of viscosity and hence improve the drying resistance of nib. JP-B-6-21250 discloses a recording liquid which comprises dialkyl ether incorporated therein to have a high fixing rate. JP-A-11-228884 discloses an ink composition comprising a pigment, a humectant and an aqueous medium wherein the residual water content is from 0.5 to 10 g per 100 g of the ink.

In the case where the foregoing aqueous ink is used for printing, printing can difficultly be made on a recording material having no ink absorptivity. Even when a dedicated paper is used, a large-sized ink dryer is required. Further, oozing problem makes high precision printing difficult, restricting resolution. Thus, the foregoing aqueous ink is limited in its use. From the standpoint of advantage of quick drying, a solvent ink may be used. However, such a solvent ink is not necessarily desirable from the standpoint of combustibility and environmental safety. A hot-melt type oil ink allows high speed printing. However, due to its characteristics, a hot-melt type oil ink gives a thick printed dot having a thickness as great as from 10 to 20 μm and thus exhibits a deteriorated abrasion resistance, making it difficult to provide a high reliability after printing.

The ink jet recording process involving the use of an organic pigment as a colorant is much more advantageous than the ink jet recording process involving the use of a dye with respect to weathering resistance in particular and thus can be expected to be used not only for office printers such as OA apparatus, ordinary household printer and facsimile but also in printing on indoor/outdoor poster, large-sized signboard, automobile, glass, elevator, wall and building ornament, and cloth. However, the foregoing problem that high reliability printing cannot be accomplished causes a bottleneck in the way of marketing of this ink jet recording process.

### SUMMARY OF THE INVENTION

The present invention provides an ink composition for ink jet printer which can dry quickly to make high quality printing on a non-coated paper and its printing mechanism. A further important object of the invention is to provide a pigment ink composition for high speed ink jet printer having an ejection stability high enough for the ejection of ink droplet from a fine nozzle.

The essence of the present invention for solving the foregoing problems lies in an ink jet printer which performs recording by allowing an ink droplet to be attached to plain paper, characterized in that there is used an ink composition comprising at least water, a pigment and a water-soluble organic solvent which exhibits a weight loss of from 10% to 40% based on the total weight of ink, a 25° C. surface tension increase of not smaller than 1 mN/m from the initial value and a viscosity change of not greater than 150% of the initial value after 24 hours of aging at a temperature of 25° C. and 60%RH (relative humidity).

The ink jet printer preferably employs plain paper having a thickness of from 80 to 200 μm, a Bekk smoothness of not greater than 80 s and a pH value of not greater than 6.5.

The ink jet printer performs printing at a speed of not smaller than 10 ips and may further comprise a mechanism for drying recorded dots and/or a double-sided printing mechanism.

The water-soluble organic solvent to be incorporated in the ink composition for use in the ink jet printer of the invention preferably exhibits a vapor pressure of not higher than 1 mmHg at 20° C. The amount of the water-soluble organic solvent to be incorporated in the ink composition is preferably from 0.1 to 10% by weight.

The ink composition for use in the ink jet printer of the invention is an ink set containing carbon black or at least one selected from the group consisting of carbon black and organic pigments including yellow, magenta and cyan pigments.

### BRIEF DESCRIPTION OF THE DRAWING

FIG. 1 is a graph illustrating the change of surface tension and viscosity of ink with time.

### DETAILED DESCRIPTION OF THE PRESENT IVENTION

The weight loss of the ink composition and the change of the surface tension and viscosity of the ink composition with time which characterize the invention will be described hereinafter.

Heretofore, it has been thought that the change of surface tension of ordinary ink composition with time is an undesirable phenomenon that must be avoided for ink. It was found in the invention that by reversing and using the conventional common sense about ink in a favorable light, ordinary ink composition can be very effectively adapted for properties necessary for ink jet recording. The present invention has been worked out on the basis of this discovery.

Many approaches have heretofore been made to realize high dryability of print in aqueous ink jet recording process. For example, an approach comprises allowing the ink to penetrate into a dedicated paper having a coated portion as an ink absorption layer to allow the recorded dot to dry. In other words, it is well known in the art that by controlling the surface tension of the ink to as low as about 30 mN/m, the initial surface tension can be maintained to stabilize ejection and hence raise the speed of penetration into the paper, making it possible to realize desired properties, even after the change of ink components due to evaporation.

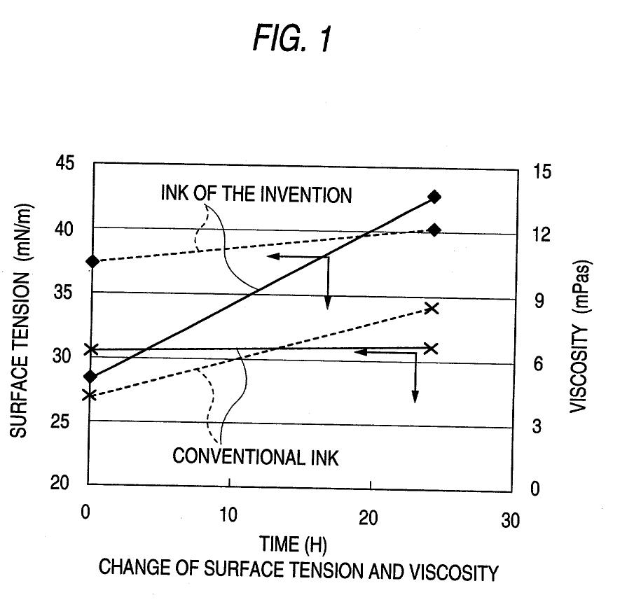

However, ink jet printing has been recently found disadvantageous partly in that the ink causes much show through on the back surface of the paper, particularly deterioration of image quality during double-sided printing. This phenomenon has been individually coped with by many means. For example, a method is employed which comprises allowing the water content in the recorded dot attached to the recording paper to evaporate so that the ink component becomes thicker than initial by scores of times to lose fluidity, making it possible to fix the recorded image. Another method may be employed which comprises insolubilizing the ink composition in the recording medium with a reaction solution or processing solution. However, these recording methods are accompanied by time delay and thus are not suitable for high speed printing. The application of these recording methods to plain paper free of coating layer in high speed printing, which is intended for the invention, has never been studied thoroughly. The inventors made extensive studies of this phenomenon of ink show through and properties of ink composition. As a result, it was found that the ejection properties of printing head should not be excessively considered as heretofore. In other words, the surface tension of the ink should not be kept invariably even after attached to the interior of the nozzle or formed in dot. It was thus found that the change of surface tension of ink with time is related to the foregoing phenomenon. This can be made obvious in FIG. 1, which indicates that the change of surface tension and viscosity of the ink composition of the invention differs from the conventional ink. In other words, the conventional ink composition comprising water as a main solvent exhibits a lowered initial surface tension so that it can quickly permeates the paper. Therefore, even when water, which is a high surface tension component, has evaporated, the ink composition shows no change of surface tension. Further, even an ink having a high surface tension normally shows a drop of surface tension after the evaporation of water. Moreover, it has been practiced to raise the viscosity of the ink by 50% or more and hence prevent the ink from running horizontally in the paper.

It should be noted that the present invention is based on the standpoint of high speed printing on a non-coated paper unlike the conventional penetration drying type ink composition. The ink composition of the invention can provide an effective inhibition of change of surface tension with time, i.e., phenomenon of rise of surface tension with decrease of ink weight followed by maintenance in a proper range and concurrent ink show through. In some detail, the percent drop of weight of the ink after 24 hours of aging at a temperature of 25° C. and 60%RH is from 10% to 40% of the total amount of ink. At this point, the ink shows a 25° C. surface tension rise of not smaller than 1 mN/m from the initial value. Further, in order to stabilize ejection and prevent the penetration of the ink into the recording medium, it is preferred that the viscosity rise be not greater than 50% of the initial value. The essence of the present invention lies in the relationship between the physical properties defined by the percent drop of weight of ink and the ink jet recording properties. Thus, the present invention can be applied to all ink compositions which exhibit a weight loss of from 10% to 40% of the total weight of the ink after 24 hours of aging. When the percent weight loss is not smaller than 40% after 24 hours of aging, it means that the ink dries much quickly in the initial stage, causing remarkably drying at the end face of the nozzle and hence malejection. Referring to actual evaluation conditions, since the area of the ink in contact with air is about 250 cm², the weight of the ink needs to be about 40 g. When the surface area of the ink is as small as about 25 cm², printing cannot be fairly controlled.

It was found that as an important component for accomplishing the object of the invention there may be preferably used a water-soluble organic solvent having a vapor pressure of not greater than 1 mmHg at 20° C. A water-soluble organic solvent which exhibits a low viscosity, exerts an effect of preventing drying in nozzle and causes neither corrosion nor deterioration of ambient members is desirable. In particular, a glycol ether is colorless and odorless and has an ether group and a hydroxyl group in its molecule. Thus, a glycol ether is a liquid having both the properties of alcohol and ether. Therefore, a glycol ether not only acts on the surface of ink but also becomes compatibilized somewhat with the core of ink as an ether-based surface active agent does, inhibiting foaming that prevents the ejection of ink. Thus, a glycol ether is suitable. Examples of such a glycol ether include ethylene glycol ether such as methyl glycol, methyl diglycol, methyl triglycol, methyl polyglycol, butyl glycol, butyl diglycol, butyl triglycol and isobutyl glycol (all produced by Nippon Nyukazai Co., Ltd.), and propylene glycol-based ether such as methyl propylene glycol, methyl propylene diglycol, methyl propylene triglycol, propyl propylene glycol, propyl propylene diglycol, butyl propylene glycol, butyl propylene diglycol and phenyl propylene glycol (all produced by Nippon Nyukazai Co., Ltd.). Particularly useful among these glycol ethers are those having a vapor pressure of not greater than 1 mmHg at 20° C. Those having a vapor pressure of greater than 1 mmHg at 20° C. dry too fast and thus makes ejection unstable.

Other examples of the surface active agent employable herein include anionic surface active agents such as carboxylate, sulfuric acid ester, sulfonate and phosphoric acid ester, cationic surface active agents such as alkylamine salt, dialkylamine salt, tetralkylammonium benzalconium salt, alkyl pyridium salt and imidazolinium salt, amphoteric surface active agents such as carboxybetaine, sulfobetainaminocarboxylic acid and phosphoric acid ester, ether-based surface active agents, ester-based surface active agents, etherester-based surface active agents, and nitrogen-containing surface active agents. Specific examples of these ether-based surface active agents, ester-based surface active agents, etherester-based surface active agents, and nitrogen-containing surface active agents include nonionic surface active agents such as polyoxyethylene alkyl ether, polyoxyethylene alkyl allyl ether, polyoxyethylene polyoxypropylene glycol, glycerin ester, sorbitan ester, sucrose ester, polyoxyethylene ether of glycerin, polyoxyethylene ether of sorbitan ester, polyoxyethylene ether of sorbitol, aliphatic acid alkanolamide and amine oxide. Glycerin aliphatic acid esters and sucrose esters which have been approved to be added to food are highly safe and thus can be widely used.

The amount of such a surface active agent to be added is not specifically limited. In practice, however, the excessive addition of such a surface active agent deteriorates print quality. Thus, such a surface active agent is preferably added in an amount of from 0.1 to 10% by weight.

In addition to the foregoing additives, ethylene glycol, propylene glycol, diethylene glycol, dipropylene glycol, triethylene glycol, pentamethylene glycol, polyethylene glycol (all produced by Wako Pure Chemical Industries, Ltd.), acetylene glycol (produced by Nissin Chemical Industry Co., Ltd.), etc. can be used to prevent drying in the nozzle. For the purpose of further improving ejectability, the ink composition may comprise a glycerin incorporated therein. Urea, too, is useful because it can prevent drying. Specific examples of these compounds include PEG200, PEG300, PEG400, PEG600, PEG1000, PEG1540, PEG2000, PEG4000, PEG11000, PEG20000, Uniol D250, D400, D700, D1000, D1200, D2000, D3000, D4000, TG330, TG1000, TG3000, TG4000, Unilube 50MB-2, 50MB-5, 50MB-11, 50MB-26, 50MB-72, 50MB-168, 50DE-25, 75DE-25, 75DE-60, 75DE-170, 75DE-250, 75DE-2620, 75DE-3800, 75DE-5000 (all produced by NOF Corp.), etc. At least one of these compounds may be used. Alternatively, two or more of these compounds may be used in admixture.

In order to improve the properties of the ink composition, ketones or lower alcohols such as acetone, methyl ethyl ketone, methyl isobutyl ketone, methanol, ethanol and isopropanol, glycols such as ethylene glycol, propylene glycol, diethylene glycol and dipropylene glycol, acetates, or nitrogen-containing compounds such as thiodiglycol, N-methyl-2-pyrrolidone, 1,3-dimethylimidazolidinone and aminoalcohol may be used singly or in admixture. Other examples of these compounds employable herein include diethylene glycol, polyethylene glycol, glycerin, NMP, sodium lactate, DMSO, ethylene glycol alkyl ether, and diethylene glycol alkyl ether.

As physical property adjustors there may be used various additives such as metal oxide (e.g., KOH), surface active agent, alcoholamine (e.g., diethanolamine, triethanolamine), alcoholamine salt or ammonium salt of phosphoric acid or strong acid, hydroxycarboxylic acid (e.g., lower carboxylic acid, glycolic acid, lactic acid), biocide (e.g., sodium benzoate, potassium sorbate, thiabendazole, benzimidazole), chelating agent, deoxidizer, defoaming agent, electrostat and electrically-conducting agent depending on the purpose.

In order to further improve the properties of the ink composition, a high molecular compound can be used. For example, as anionic surface active agents there may be used synthetic anionic surface active agents such as styrene-maleic anhydride copolymer, olefin-maleic anhydride copolymer, formaline condensate of naphthalenesulfonic acid, sodium polyacrylate and polyacrylamide partial hydrate or natural anionic surface active agents such as sodium alginate. Examples of cationic surface active agents employable herein include synthetic cationic surface active agents such as polyethyleimine, polyvinyl imidazoline, aminoalkyl (meth)acrylate-acrylamide copolymer and mannich-modified polyacrylamide, and natural cationic surface active agents such as chitosan. Examples of nonionic surface active agents employable herein include synthetic nonionic surface active agents such as polyvinyl alcohol, polyoxyethylene ether ester copolymer and polyacrylamide, and natural nonionic surface active agents such as starch. Further, a resin emulsion, too, is effective.

As the pigment which is an essential component for accomplishing the object of the invention there is preferably used one having an excellent weathering resistance which can be fairly dispersed in the foregoing vehicle. The color developability (color density per concentration added) of pigments which are particularly used in the invention is not necessarily high. In addition, it is difficult to prepare a homogeneous particle dispersion. Therefore, when the pigment is incorporated in a high concentration, the resulting ink composition exhibits a raised melt viscosity. Thus, such an ink composition has not heretofore been put in practical use. Though not specifically limited, organic or inorganic pigments having the following index number described in Color Index can be used.

As red or magenta pigments there may be used Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 179, 184, 185, 208, 216, 226, 257, Pigment Violet 3, 19, 23, 29, 30, 37, 50, 88, and Pigment Orange 13, 16, 20, 36 depending on the purpose. As blue or cyan pigments there may be used Pigment Blue 1, 15, 15:1, 15:2, 15:3, 15:4, 15:6, 16, 17:1, 22, 27, 28, 29, 36, 60 depending on the purpose. As green pigments there may be used Pigment Green 7, 26, 36, 50 depending on the purpose. As yellow pigments there may be used Pigment Yellow 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, 193 depending on the purpose. As black pigments there may be used Pigment Black 7, 28, 26 depending on the purpose.

Specific examples of the trade name of these pigments include Chromofine Yellow 2080, 5900, 5930, AF-1300, 2700L, Chromofine orange 3700L, 6730, Chromofine Scarlet 6750, Chromofine Magenta 6880, 6886, 6891N, 6790, 6887, Chromofine Violet RE, Chromofine Red 6820, 6830, Chromofine Blue HS03, 5187, 5108, 5197, 5085N, SR-5020, 5026, 5050, 4920, 4927, 4937, 4824, 4933GN-EP, 4940, 4973, 5205, 5208, 5214, 5221, 5000P, Chromofine Green 2GN, 2GO, 2G-550D, 5310, 5370, 6830, Chromofine Black A-1103, Seika Fast Yellow 10GH, A-3, 2035, 2054, 2200, 2270, 2300, 2400(B), 2500, 2600, ZAY-260, 2700(B), 2770, Seika Fast Red 8040, C405(F), CA120, LR-116, 1531B, 8060R, 1547, ZAW-262, 1537B, GY, 4R-4016, 3820, 3891, ZA-215, Seika Fast Carmine 6B1476T-7, 1483LT, 3840, 3870, Seika Fast Bordeaux 10B-430, Seika Light Rose R40, Seika Light Violet B800, 7805, Seika Fast Maroon 460N, Seika Fast Orange 900, 2900, Seika Light Blue C718, A612, Cyanine Blue 4933M, 4933GN-EP, 4940, 4973 (all produced by DAINICHISEIKA COLOUR & CHEMICALS MFG. CO., LTD.), KET Yellow 401, 402, 403, 404, 405, 406, 416, 424, KET Orange 501, KET Red 301, 302, 303, 304, 305, 306, 307, 308, 309, 310, 336, 337, 338, 346, KET Blue 101, 102, 103, 104, 105, 106, 111, 118, 124, KET Green 201 (all produced by DAINIPPON INK & CHEMICALS, INC.), Colortex Yellow 301, 314, 315, 316, P-624, 314, U10GN, U3GN, UNN, UA-414, U263, Finecol Yellow T-13, T-05, Pigment Yellow 1705, Colortex Orange 202, Colortex Red 101, 103, 115, 116, D3B, P-625, 102, H-1024, 105C, UFN, UCN, UBN, U3BN, URN, UG276, U456, U457, 105C, USN, Colortex Maroon 601, Colortex Brown B610N, Colortex Violet 600, Pigment Red 122, Colortex Blue 516, 517, 518, 519, A818, P-908, 510, Colortex Green 402, 403, Colortex Black 702, U905 (all produced by Sanyo Colorworks, Ltd.), Lionol Yellow 1405G, Lionol Blue FG7330, FG7350, FG7400G, FG7405G, ES, ESP-S (all produced by TOYO INK MFG. CO., LTD.), Toner Magenta E02, Permanent Rubin F6B, Toner Yellow HG, Permanent Yellow GG-02, Hostapeam Blue B2G (all produced by Hoechst Industry Inc.), and Carbon Black #2600, #2400, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, CF9 (all produced by Mitsubishi Chemical Corporation). Alternatively, a dispersion having a pigment dispersed in water or a solvent in a high concentration may be used. Examples of such a dispersion employable herein include KIJ200-23-2, KIJ200-23-1 (all produced by Ciba Specialty Chemicals Co., Ltd.), MICROPIGMO WMBK-5, WBME-5, WMRD-5, WMYW-5, AMBK-2, AMYW-2, AMBE-4 (all produced by Orient Chemical Industries Ltd.), JA Black 25W, GA Black 2821, GA Yellow 1, GA Magental, GA Cyan 2 (all produced by Mikuni Color Limited), and CAB-0-JET200, CAB-0-JET300 (all produced by Cabot Specialty Chemicals Inc.). In particular, a dispersion having a pigment dispersed therein in a concentration as high as not smaller than 10% by weight is desirable.

The concentration of the pigment to be incorporated in the ink composition is preferably from 2% to 10% by weight. When the pigment concentration falls below 2% by weight, the resulting image quality is deteriorated. On the contrary, when the pigment concentration exceeds 10% by weight, the viscosity of the ink composition is adversely affected. Two or more colorants may be properly used in admixture for the purpose of adjusting color. The ink composition of the ink may comprise alight-stabilizer, a surface treatment, a surface active agent, a viscosity depressant, an oxidation inhibitor, an age resistor, a crosslinking accelerator, an oxygen absorbent, a plasticizer, an antiseptic agent, a biocide, an evaporation accelerator, a pH adjustor, a defoaming agent, a foaming stabilizer, a humectant, a dispersant, a dye, etc. incorporated therein to provide the ink composition with further functions.

For the mixing and dispersion of the foregoing vehicle, pigment and other components, a stirrer, bead mill, homogenizer or the like is optimum. Various known stirrers, grinders or dispersing apparatus can be used without any special restriction.

The paper for the purpose of the invention belongs to a part of non-coated paper, special printing paper and data paper. A non-coated paper having a thickness of from 80 μm to 200 μm is desirable. As paper classification there is often used one used by the Ministry of International Trade and Industry in its statistics of industrial production. According to this classification, paper can be roughly divided into four groups, i.e., printing data paper, wrapping paper, sanitary paper and miscellaneous paper. Printing data paper can be divided into five groups, i.e., non-coated paper, slightly coated paper, coated paper, special printing paper and data paper. There are various paper formulations depending on the pulp material used, the kind and amount of coating compound, the producing method, etc. There are many methods for evaluating and classifying paper. For example, paper is evaluated for density, thickness, longitudinal/crosswise direction (paper-making direction), voids, air permeability, water absorption/oil absorption, sizing, surface roughness, gloss, pH, surface strength, peel strength, rigidity, bending strength, chargeability, etc. These properties each have an effect on print quality. The inventors paid their attention to the thickness of paper as an index for generally defining the paper in the art intended by the invention. Examples of the paper to which the invention is applied include high class printing paper, middle class printing paper, low class printing paper, thin printing paper, slightly coated printing paper, special printing paper such as color paper, form paper, PPC paper, and other data paper. Specific examples of these papers include the following papers and those prepared by modifying/processing these papers, but the present invention should not be construed as being limited thereto.

Synthetic paper such as high quality paper, high quality color paper, recycled paper, copying paper, colored copying paper, OCR paper, non-carbon paper, colored non-carbon paper, Yupo Coat 60, 80, 110 micron, and Yupo Coat 70, 90 micron, single-sided art paper 68 kg, coated paper 90 kg, form mat paper 70, 90, 110 kg, foam PET38 micron, Mitsuorikun (all produced by KOBAYASHI KIROKUSHI Co., Ltd.), OK high quality paper, New OK high quality paper, Sunflower, Fenics, OK Royal White, exported high quality paper (NPP, NCP, NWP, Royal White), OK book paper, OK cream book paper, cream high quality paper, OK map paper, OK Ishikari, Kyurei, OK form, OKH, NIP-N (all produced by SHIN OJI SEISHI Co., Ltd.), Kinou, Tokou, High quality paper for expotation, High quality paper for special procurement, book paper, book paper L, light cream book paper, paper for elementary school scientific textbook, continuous slip paper, high quality NIP paper, Ginkan (silver ring), Kinyo, Kinyo (W), bridge, capital, Ginkan book paper, harp, harp cream, SK color, bill paper, opera cream, opera, KYP chart, Silvia HN, excellent form, NPI form DX (all produced by Nippon Paper Industries Co., Ltd.), pearl, Kanabishi, light cream high quality paper, special book paper, super book paper, book paper, Diaform, ink jet form (all produced by Mitsubishi Paper Mills, Ltd.), Kanamari V, Kanamari SW, Hakuzo, high quality publishing paper, Cream Kanamari, Cream Hakuzo, bill/valuable paper, book paper, map paper, copying paper, HNF (all produced by HOKUETSU PAPER MILLS, LTD.), Shiorai, telephone directory paper, book paper, Cream Shiorai, Cream Shiorai Middle Rough, Cream Shiorai High Rough, DSK (all produced by Daishowa Paper Mfg. Co., Ltd.), Sendai MP high quality paper, Nishikie, Raicho High Quality Paper, raw color paper, dictionary paper, cream book paper, white book paper, cream high quality paper, map paper, continuous slip paper (white) (all produced by Chuetsu pulp & paper, Ltd.), OP Kanazakura, Kinsa, reference book paper, exchange bill paper (white), form printing paper, KRF, white form, color form, (K)NIP, Fine PPC, Kishu Ink Jet paper (all produced by Kishu Paper Co., Ltd.), Taio, bright form, Kant, Kant White, Dante, CM paper, Dante Comic, Heine, library book paper, Heine S, New AD paper, Utorillo Excel, Excel Super A, Kant Excel, Excel Super B, Dante Excel, Heine Excel, Excel Super C, Excel Super D, AD Excel, Excel Super E, New Bright Form, New Bright NIP (all produced by Daio Paper Corp.), Nichirin, Getsurin, Unrei, Ginga, Hakuun, Weiss, Getsurin Ace, Hakuun Ace, Unrei Ace (all produced by Nippon Paper Industries Co., Ltd.), Taio, Bright Form, Bright NIP (all produced by Nagoya Pulp Corporation), Botan A, Kinbato, Tokubotan, Hakubotan A, Hakubotan C, Ginbato, Super Hakubotan A, Light Cream Hakubotan, special middle quality paper, Shirobato, super middle quality paper, Aobato, Akabato, Kinbato M Snow Vision, Snow Vision, Kinbato Snow Vision, Hakubato M, Super DX, Hamanasu O, Akabato M, HK super printing paper (all produced by Honshu Paper Co., Ltd.), Star Rinden (A•AW), Star Elm, Star Maple, Star Laurel, Star Poplar, MOP, Star Cherry I, Cherry I Super, Cherry II Super, Star Cherry III, Star Cherry IV, Cherry III Super, Cherry IV Super (all produced by Marusumi Paper Company Limited), SHF (produced by Toyo Pulp Co., Ltd.), TRP (produced by Tokai-Pulp&Paper Co., Ltd.).

Examples of the recording medium employable herein include high quality paper, colored high quality paper, Xerox 4024, ink jet plain paper, ink jet paper, regenerated paper, and slip paper. A paper having a thickness of from 80 μm to 200 μm which is widely used as plain paper is particularly suitable for the purpose of the invention. As the recording medium to which the invention is applied there is preferably used a non-coated paper. Referring to the proportion of elements in paper, the number of aluminum and silicon elements are preferably not greater than 150 and not greater than 200 per 100 of carbon elements.

The inventors paid their special attention to surface smoothness as an index for generally defining the paper in the art intended by the invention. Examples of surface smoothness include Bekk smoothness, testing method for smoothness by air micorometer, and chapman smoothness, which are defined in TAPPI-T479, JIS P8119. The smoothness to be measured by Bekk smoothness testing machine, smooth tar smoothness testing machine or Oken type smoothness testing machine indicates air flow rate or pressure change. The smoothness values measured by these smoothness testing machines can be converted to each other. Any of the papers intended by the invention is a non-coated paper having a Bekk smoothness of not greater than 80 s. The essence of the invention lies in the relationship between the physical properties defined by Bekk smoothness and the ink jet recording properties. The recording medium to be used herein is not limited to paper. The present invention can be applied to metals, plastics and other possible media having similar properties.

In color ink jet recording process, it is important that the various color ink compositions each have a fair color reproduction range itself. An ink jet coated paper having a pH value of not lower than 6.5 exhibits a fair color reproducibility. However, most plain papers having a high acidity leave something to be desired in color reproducibility. The present invention is intended to allow fair reproduction of colors on acidic paper. The pH value of paper can be easily measured, e.g., by the method defined as JAPAN TAPPI paper pulp testing method No. 6. In some detail, a pH measurement indicator solution is dropped onto the specimen on the side thereof to be measured. The indicator solution is then developed uniformly over the surface of the specimen with a cotton. When the color thus developed becomes uniform, it is then compared with the color hue in the pH standard color change table to measure pH.

The printing speed of the printer in the art intended by the invention is remarkably higher than that of conventional ink jet recording methods. The printing speed is not definitely defined. In practice, however, the recording speed is particularly preferred such that the speed of nozzle relative to paper is not smaller than 10 ips (inch/s) to make effective use of the ink composition of the invention. In order to make high speed recording, it is necessary that the ink droplet which has been attached to the recording medium be immediately fixed (set). When the ink droplet is insufficiently fixed on one sheet of paper, fatal defects can occur. For example, the unfixed ink is transferred to the back surface of another sheet of paper which is imposed thereon. The ink deposit is attached to the feed roll in the recording apparatus. Further, recorded dots are disturbed. In order to realize recording speed of 10 ips, it is necessary that recording be fixed in about 1 second after recording. In other words, in accordance with the invention, recording can be substantially handled (touched by hand or otherwise handled) in about 1 s.

Examples of the recording method by on-demand type ink jet recording using piezoelectric elements include line type recording, serial recording, transfer type (shuttle type) recording, etc. However, the present invention is not limited to these recording methods. All these recording methods involve the movement of nozzle relative to paper (recording medium) at a speed of 10 ips. In the case where only the paper moves with the head portion fixed as in the line type recording, the paper moving speed (paper feed rate) corresponds to the foregoing relative speed. In the case of serial recording, that is, in the case where the head moves perpendicular to the direction of paper feed to make successive recording while the paper is being intermittently fed, the head moving speed (carriage speed) corresponds to the foregoing relative speed. In the case where recording is made on the paper attached to a rotary drum, or in the case of transfer recording where recording is made on a drum and then transferred to the paper, the foregoing relative speed is interpreted as the speed of change of the relative position of the moving paper or drum and the nozzle. In any case, the recording speed is directly related to the frequency of ejection from nozzle and the recording resolution. For example, the paper feed speed V in the line type recording or the head moving speed V (i.e., recording speed) in the serial recording is represented by the equation V=f×R where f is the frequency of ejection of ink droplet and R is the recording resolution.

Many ink compositions which have heretofore been reported can be directly applied to the conventional recording method involving the relative speed of not greater than 5 ips (normally not greater than 1 ips). The present invention can be effectively used in high speed recording involving the relative speed of not smaller than 5 ips, particularly not smaller than 10 ips. In accordance with the invention, sufficiently practical printing properties can be realized without using any heating and drying step. However, in order to embody the high speed recording of the invention more effectively, a heating step, drying step, etc. may be added. The heating and drying step may involve heating the ink or recording medium while in contact with the recording medium. Alternatively, the heating and drying step may be a non-contact heating process which comprises irradiating the recording medium with infrared rays or blowing hot air onto the recording medium. The proper temperature at which drying is effected is preferably not higher than 180° C. so that the recording medium undergoes neither fuming nor discoloration.

The method for double-sided printing is not specifically limited. In practice, however, it is necessary that the ink composition to be used in the ink jet printer have a sufficiently low viscosity to stabilize ejection. In this case, when the ink in the form of low viscosity liquid permeates the recording paper, it also reaches the back surface. Thus, such an ink composition is not suitable for double-sided printing. Accordingly, the viscosity of the ink composition for double-sided printing is preferably not smaller than 7 mPs·s. When recording is conducted on both surfaces of paper at the same time, a large amount of ink is attached to the recording paper, causing a remarkable deterioration of image quality. Thus, a method is preferably employed which comprises recording on one surface of the paper, drying the surface, and then recording on the other. Alternatively, an ink transfer material may be provided so that a single head can make double-sided printing. The latter method is even more desirable for higher speed and lower price.

For the preparation of a high quality ink jet ink, many important factors need to be well balanced. These requirements are complicated and thus cannot necessarily be definitely expressed numerically for the ink composition of the invention. However, the ink composition of the invention satisfies some known requirements to find application to ink jet printer. In other words, the ink composition of the invention is sufficiently stable at room temperature and thus is reliable in storage before printing and image quality after printing. The ink composition which has been attached to and cured on the recording medium has a sufficient transparency and saturation and forms a uniform thin film to give a printed matter with a good image quality. It is necessary that the ink composition of the invention cause no show through when sheets of printed matter are imposed on each other. The ink composition of the invention also needs to have a high safety taking into account environmental protection and human health.

Further, the ink composition of the invention can be used for conventional known ink jet printers which perform recording by ejecting ink droplets only when printing is necessary, such as office printer, printer for industrial marking, wide format printer, printing plate-making printer, label printer and any other types of high speed printers having such a typical operation. Since the ink composition of the invention can dry quickly, a cloth made of plastic film, capsule, jell, metal foil, glass, acryl plate, wood, natural textile, synthetic textile, mixture thereof, etc. maybe used as a recording medium besides the foregoing kinds of paper. Since the ink composition of the invention allows non-contact printing, the shape of the recording medium is not limited to the foregoing shapes but may vary widely.

The present invention will be further described in the following examples, but the present invention should not be construed as being limited thereto.

### EXAMPLES 1-4

42% by weight of purified water, 50% by weight of glycerin, 5% by weight of dipropylene glycol monomethyl ether and 3% by weight of N,N-dimethylethanolamine were used (all these ingredients were available from Wako Pure Chemical Industries, Ltd.). In addition to the foregoing ingredients, as pigments there were used a black pigment dispersion (TBK-BC3, produced by Taisei Kako Co., Ltd.), a magenta pigment aqueous dispersion (GA Magental, produced by Mikuni Color Limited), a yellow pigment aqueous dispersion (KIJ200-23-2, produced by Ciba Specialty Chemicals K.K.), and a cyan pigment aqueous dispersion (KIJ200-23-2, produced by Ciba Specialty Chemicals K.K.) each in an amount of 4% by weight based on the total weight of the mixture. 300 g of each of these mixtures was then subjected to dispersion at a rotary speed of 2,000 rpm by means of a homogenizer (HG30, produced by Hitachi Koki Co., Ltd.) until a homogeneous mixture was obtained. Thus, four homogeneous ink compositions were obtained. The results are set forth in Table 1.

TABLE 1

| | | | | | Comparative | | |
|---|---|---|---|---|---|---|---|
| | Example Nos. | | | | Example Nos. | | |
| Ink formulation | 1 | 2 | 3 | 4 | 1 | 2 | 3 |
| Water | 42 | 42 | 42 | 42 | | | |
| Glycerin | 50 | 50 | 50 | 50 | | | |
| Dipropylene glycol | 5 | 5 | 5 | 5 | | | |
| monomethyl ether | | | | | | | |
| N,N-dimethylethano | 3 | 3 | 3 | 3 | | | |
| 1 amine | | | | | | | |
| Isoper-H | | | | | 97 | | |
| Isoper-L | | | | | | 97 | |
| Isoper-M | | | | | | | 97 |
| Solsperse 17000 | | | | | 3 | 3 | 3 |
| TBK-BC3 | 4 | | | | | | |
| GA Magental | | 4 | | | | | |
| KIJ200-23-2 | | | 4 | | | | |
| KIJ200-23-1 | | | | 4 | | | |
| MA-100 | | | | | 10 | 10 | 10 |
| % Ink weight loss | 16 | 10 | 18 | 20 | 1 | 0.5 | 0 |
| Initial surface | 39 | 45 | 41.9 | 41.3 | 25 | 25.6 | 26 |
| tension (mN/m) at | | | | | | | |
| 25° C. | | | | | | | |
| Surface tension | 40 | 63 | 50.4 | 52.3 | 25.1 | 25.4 | 26 |
| (mN/m) at 25° C. after | | | | | | | |
| 24 hours | | | | | | | |
| Initial viscosity | 7.8 | 7 | 12 | 9.5 | 3 | 2.5 | 2.8 |
| (mPa · s) at 25° C. | | | | | | | |
| Viscosity (mPa · s) at | 11.5 | 8 | 17.5 | 14 | 3.1 | 2.5 | 2.9 |
| 25° C. after 24 hours | | | | | | | |
| Show through | G | G | E | E | P | P | P |
| Dot shape | E | G | E | E | P | P | P |

For the determination of the percent drop of weight of ink composition, about 40 mg of the ink composition was put in an open glass vessel having a surface area of about 250 cm². The weight of the ink composition was immediately measured. The ink composition was then allowed to stand at a temperature of 25° C. and 60%RH (relative humidity) under windless conditions for 24 hours. The weight of the ink composition was then again measured. From the measurements was then calculated the percent weight loss. All the examples and comparative examples showed a percent weight loss of from 10% to 20%.

For the measurement of surface tension, an automatic surface tensiometer (Type CVBP-Z, produced by Kyowa Interfacial Science Co., Ltd.) was used. For the measurement of viscosity, a rotational viscometer (Type EDL, produced by TOKIMEC INC.) was used. The initial surface tension of these examples and comparative examples at 25° C. was from 39 to 45 mN/m. The initial viscosity of these examples and comparative examples at 25° C. was from 7 to 12 mPa·s. These examples and comparative examples exhibited a surface tension of from 40 to 63 mN/m and from 8 to 17.5 mPa·s after 24 hours of aging at a temperature of 25° C. and 60%RH.

For the measurement of thickness of paper, a micrometer was used. For the measurement of Bekk smoothness, an Oken gas transmission/smoothness testing machine (KY-5, produced by ASAHI SEIKO CO., LTD.) was used. These measurements were conducted at a temperature of 25° C. For the evaluation of these properties, 55 kg paper and 135 kg paper (NIP paper produced by KOBAYASHI KIROKUSHI Co., Ltd.) were used as recording medium. A direct plate-making machine (SJ02A, produced by Hitachi Koki Co., Ltd.) was freed of head portion and fixed. Using the print testing machine thus prepared, printing was then made on the surface of the paper at an ink ejection rate of 3 kHz and a paper feed rate of 10 ips with a resolution of 300 (×600) dpi. The thickness of these recording media (55 kg paper and 135 kg paper) were 87.8 μm and 190.6 μm, respectively. The Bekk smoothness of these recording media were 46.5 s and 23.8 s, respectively. The measurement of pH value was conducted according to JAPAN TAPPI paper pulp testing method No. 6. Both these recording media exhibited a pH value of 2.6. The results of printing were evaluated according to the following criteria.

(1) Show through:

How the ink penetrates to the back surface of the paper was visually observed (ink oozing).

(2) Dot shape:

Feathering involving the disturbance of ink dot along the fibers of the paper was visually observed. In the tables, E indicates excellent, G indicates good, and P indicates that the dot form is too poor to use.

The results of evaluation of printing made on the ink compositions of Examples 1 to 4 were all excellent or good, demonstrating that these ink compositions allow good printing on ordinary strong acidity paper.

### COMPARATIVE EXAMPLES 1 to 3

97% by weight of Isoper H, L or M (produced by Exxon Chemical Inc.), Solsperse 17000 (produced by ICI), and 10% by weight of Carbon Black MA-100 (produced by Mitsubishi Kasei Corp.) as a black pigment were mixed to prepare six ink analogues where were then measured and evaluated in the same manner as in Example 1. All these comparative examples exhibited a percent weight loss of less than 10% and showed poor results of evaluation of printing properties, demonstrating that these ink compositions are not suitable for printing on plain paper.

### EXAMPLES 5-8; COMPARATIVE EXAMPLES 4-5

47% by weight of purified water, 40% by weight of dipropylene glycol, 3% by weight of sucrose ester (all produced by Wako Pure Chemical Industries, Ltd.) and 10% by weight of each of various alkylene glycol alkyl ethers set forth in Table 2 below were mixed. To these mixtures were each then added a black pigment dispersion (Micropigmo WBMK-5, produced by Orient Chemical Industries Ltd.) in an amount of 2% by weight of 2% by weight based on the total weight of the mixture. The various ink compositions thus prepared were each then evaluated in the same manner as in Example 1. The results are set forth in Table 2 below.

TABLE 2

| | | | | | Comparative | |
|---|---|---|---|---|---|---|
| | | | | | Example | |
| | Example Nos. | | | | Nos. | |
| Ink formulation | 5 | 6 | 7 | 8 | 4 | 5 |
| Water | 47 | 47 | 47 | 47 | | |
| Dipropylene glycol | 40 | 40 | 40 | 40 | | |
| Sucrose ester | 3 | 3 | 3 | 3 | | |
| Dipropylene glycol | 10 | | | | | |
| monomethyl ether | | | | | | |
| Dipropylene glycol | | 10 | | | | |
| monopropyl ether | | | | | | |
| Tripropylene glycol | | | 10 | | | |
| monomethyl ether | | | | | | |
| Diethylene glycol | | | | 10 | | |
| monomethyl ether | | | | | | |
| MICROPIGMO WBMK-5 | 2 | 2 | 2 | 2 | 10 | 10 |
| % Ink weight loss | 30 | 25 | 38 | 32 | 22 | 32 |
| Initial surface tension | 39 | 45 | 50 | 30 | 25 | 32 |
| (mN/m) at 25° C. | | | | | | |
| Surface tension (mN/m) at | 50 | 52 | 58 | 31 | 25.3 | 32.8 |
| 25° C. after 24 hours | | | | | | |
| Initial viscosity (mPa · s) | 9 | 10.5 | 13 | 11 | 2.5 | 4.3 |
| at 25° C. | | | | | | |
| Viscosity (mPa · s) at 25% | 9.8 | 15 | 19 | 14 | 5.1 | 8.1 |
| after 24 hours | | | | | | |
| Show through | G | G | g | E | P | P |

All the ink compositions of the examples exhibited a percent weight loss of from 25% to 38%, an initial surface tension of from 30 to 50 mN/m at 25° C. and viscosity of from 9 to 13 mPa·s at 25° C. These ink compositions exhibited a surface tension of from 31 to 58 mN/m and a viscosity of from 9.8 to 19 mPa·s after 24 hours of aging at a temperature of 25° C. and 60%RH.

On the contrary, the two commercial ink compositions exhibited a percent weight loss of 22% and 32%, respectively, an initial surface tension of 25 mN/m and 32 mN/m, respectively, at 25° C. and a viscosity of 2.5 mPa·s and 4.3 mPa·s, respectively, at 25° C. The two commercial ink compositions exhibited a surface tension of 25.3 and 32.8 mN/m, respectively, and a viscosity of from 5.1 to 8.7 mPa·s after 24 hours of aging at a temperature of 25° C. and 60%RH.

The ink compositions of Examples 5 to 8 and the two commercial inks were printed on 11 kinds of commercial paper, and then compared for dot area. These ink compositions were also measured and evaluated in the same manner as in Example 1. The results are set forth in Table 3 below.

TABLE 3

| | | | | Dot area (μm²) | | | | | |
|---|---|---|---|---|---|---|---|---|---|
| | | Bekk | | | | | | Comparative Examples | |
| | Thickness | smoothness | | Example Nos. | | | | Commerical | Commerical |
| Classification | (μm) | (s) | pH | 5 | 6 | 7 | 8 | ink 1 | ink 2 |
| IJpaper1 | 127.8 | 109.0 | 6.6 | 3,561 | 4,757 | 3,569 | 4,539 | 6,764 | 4,926 |
| IJpaper2 | 124.8 | 156.3 | 7.6 | 4,645 | 4,575 | 4,742 | 4,692 | 6,816 | 5,547 |
| IJpaper3 | 121 | 80.8 | 5.8 | 2,898 | 3,884 | 4,022 | 3,954 | 7,569 | 5,879 |
| IJpaper4 | 110.8 | 395.0 | 7.4 | 6,354 | 7,723 | 7,291 | 7,391 | 9,662 | 7,386 |
| IJpaper5 | 187.8 | 114.7 | 6.8 | 5,710 | 7,185 | 6,956 | 7,153 | 9,214 | 8,081 |
| Plain | 87.8 | 46.5 | 2.6 | 5,517 | 7,675 | 7,326 | 7,225 | 10,506 | 10,793 |
| paper 1 | | | | | | | | | |
| Plain | 126.6 | 39.9 | 2.6 | 5,397 | 7,531 | 7,979 | 7,461 | 10,270 | 10,456 |
| paper 2 | | | | | | | | | |
| Plain | 100 | 31.0 | 6.5 | 3,188 | 6,924 | 6,742 | 6,724 | 9,914 | 10,855 |
| paper 3 | | | | | | | | | |
| Plain | 102.2 | 27.8 | 5.2 | 4,456 | 7,873 | 7,203 | 7,897 | 11,800 | 12,942 |
| paper 4 | | | | | | | | | |
| Plain | 190.6 | 23.8 | 2.6 | 4,256 | 7,821 | 6,941 | 7,121 | 10,959 | 12,758 |
| paper 5 | | | | | | | | | |
| Plain | 102.6 | 77.2 | 5.6 | 4,486 | 7,227 | 6,729 | 7,164 | 11,796 | 13,456 |
| paper 6 | | | | | | | | | |

All the ink jet (IJ) papers 1 to 5 comprise an ink-receptive layer laminated thereon. The plain papers 1 to 6 each are a non-coated paper. As can be seen in Table 3, all the ink jet papers have a Bekk smoothness of greater than 80 s and a pH value of greater than 6.5. All the plain papers exhibit a Bekk smoothness of not greater than 80 s and a pH value of less than 6.5.

For the measurement of dot form, an image taken into a CCD camera through a microscope having a magnification power of 20 was analyzed using an automatic image quality software (Image Pro Plus, produced by Media Cybermetrics Co., Ltd.) The number of dots measured was from 30 to 100. The results show that all the ink compositions of the invention give dots having a small diameter (little spread of dot due to oozing) as compared with the comparative commercial inks 1 and 2 (Comparative Examples 4 and 5). Although there is some difference in dot area on ink jet papers between ink compositions, all the ink compositions give a small dot area (e.g., not greater than 10,000 μm²) and thus can be put in practical use without any special problems. However, Referring to the results of printing on non-coated papers having a Bekk smoothness of not greater than 80 s, the comparative ink compositions exhibit a dot area of greater than 10,000 μm² die to oozing and hence a remarkable disturbance (feathering) and thus can never be put in practical use. On the contrary, the ink compositions of the invention are shown much advantageous in that they can be practically used also on these plain papers.

The ink composition for ink jet printer of the invention is little subject to increase of running cost on printing on dedicated papers and ink set-off on printing on plain papers, which occur with the conventional aqueous ink compositions. Further, since a pigment is used as a colorant, the desired dispersion stability of colorant and sprayability of colorant can be satisfied at the same time. The ink composition comprising such a pigment exhibits a better weathering resistance than the ink compositions comprising a dye as a main colorant and thus can satisfy requirements for higher operating speed and lower price. Moreover, since the ink composition of the invention can be printed on both sides of plain paper, the ink can be prepared at a drastically improved running cost.

What is claimed is:

1. An ink jet printer which performs recording by allowing an droplet of ink to be attached to plain paper, the ink droplet comprising:
an ink composition containing water, a pigment and a water-soluble organic solvent, the ink composition after 24 hours of aging at a temperature of 25° C. and 60%RH has:
a weight loss of from 10% to 40% based on the total weight of the ink;
a 25° C. surface tension increase of not smaller than 1 mN/m from the initial value; and
a viscosity change of not greater than 150% of the initial value.

2. The ink jet printer according to claim 1, wherein the plain paper has a thickness of from 80 μm to 200 μm, a Bekk smoothness of not greater than 80 s and a pH value of not greater than 6.5.

3. The ink jet printer according to claim 1, wherein the recording speed of the ink jet printer is not smaller than 10 ips.

4. The ink jet printer according to claim 1, comprising a mechanism for drying recorded dots and/or a double-sided printing mechanism.

5. An ink composition for use in an ink jet printer, comprising:
water;
a pigment; and
a water-soluble organic solvent having a vapor pressure of not higher than 1 mmHg at 20° C.,
wherein after 24 hours of aging at a temperature of 25° C. and 60%RH, a weight loss is from 10% to 40% based on the total weight of the ink; a 25° C. surface tension increase is not smaller than 1 mN/m from the initial value; and a viscosity change is not greater than 150% of the initial value.

6. The ink composition according to claim 5, wherein the amount of the water-soluble organic solvent is from 0.1 to 10% by weight.

7. An ink composition for use in an ink jet printer, comprising:
water;
a pigment; and
a water-soluble organic solvent,
wherein after 24 hours of aging at a temperature of 25° C. and 60%RH, a weight loss is from 10% to 40% based on the total weight of the ink; and a viscosity change is not greater than 150% of the initial value;
wherein a 25° C. surface tension is from 33 to 38 mN/m in the initial stage and from 34 to 65 mN/m after 24 hours of aging at a temperature of 25° C. and 60%RH.

8. An ink composition for use in an ink jet printer, comprising:
water;
a pigment of carbon black; and
a water-soluble organic solvent having a vapor pressure of not higher than 1 mmHg at 20° C.,
wherein after 24 hours of aging at a temperature of 25° C. and 60%RH, a weight loss is from 10% to 40% based on the total weight of the ink; a 25° C. surface tension increase is not smaller than 1 mN/m from the initial value; and a viscosity change is not greater than 150% of the initial value.

9. An ink set for use in an ink jet printer, comprising:
a black ink composition comprising:
water;
a pigment of carbon black; and
a water-soluble organic solvent having a vapor pressure of not higher than 1 mmHg at 20° C.,
wherein after 24 hours of aging at a temperature of 25° C. and 60%RH, a weight loss is from 10% to 40% based on the total weight of the ink; a 25° C. surface tension increase is not smaller than 1 mN/m from the initial value; and a viscosity change is not greater than 150% of the initial value; and
a color ink composition comprising:
water;
a pigment of organic pigment; and
a water-soluble organic solvent having a vapor pressure of not higher than 1 mmHg at 20° C.,
wherein after 24 hours of aging at a temperature of 25° C. and 60%RH, a weight loss is from 10% to 40% based on the total weight of the ink; a 25° C. surface tension increase is not smaller than 1 mN/m from the initial value; and a viscosity change is not greater than 150% of the initial value.
